(19) United States
(12) Patent Application Publication
(10) Pub. No.: US 2020/0404248 A1
(43) Pub. Date: Dec. 24, 2020

(54) SYSTEM AND METHOD FOR COMPRESSED SENSING LIGHT FIELD CAMERA

(71) Applicant: Technology Innovation Momentum Fund (Israel) Limited Partnership, Tel-Aviv (IL)

(72) Inventors: David MENDLOVIC, Tel-Aviv (IL); Ariel RAZ, Tel-Aviv (IL); Ido YOVEL, Tel-Aviv (IL)

(73) Assignee: Technology Innovation Momentum Fund (Israel) Limited Partnership, Tel-Aviv (IL)

(21) Appl. No.: 16/971,385

(22) PCT Filed: Feb. 14, 2019
(86) PCT No.: PCT/IL2019/050175

§ 371 Date: Aug. 20, 2020

Related U.S. Application Data
(60) Provisional application No. 62/633,712, filed on Feb. 22, 2018.

(30) Foreign Application Priority Data
Feb. 20, 2018 (IL) 257635

(51) Int. Cl. H04N 13/282; H04N 5/225; H04N 13/106

(52) U.S. Cl. CPC H04N 13/282; G02B 5/201; H04N 13/106; H04N 5/22541

(57) ABSTRACT

A light field imaging system and method are presented. The light-field imaging system comprises an optical arrangement configured for collecting an input light field from a scene and projecting collected light on a pixel matrix of a detector unit, the optical arrangement comprising” an optical coder configured for applying angular coding to the light being collected to produce angularly coded light by separating the light being collected into an array of u angular light components corresponding to u different discrete viewpoints of the scene and projecting light from all of said u angular light components onto each of at least some of the pixels in the pixel matrix thereby causing in-pixel summation of the u angular light components on the pixel matrix of the sensor unit. A color filter unit is provided being located in a filtering plane in an optical path of the u angular light components of the angularly coded light and being configured to apply predetermined color coding to the angularly coded light propagating to the pixel matrix to thereby form on the pixel matrix an image of the input light field in a spectro-angular space.

### TECHNOLOGICAL FIELD

The present invention, in some embodiments thereof, relates to a technique for imaging a scene via computational imaging. The invention relates in particular to collection and recording of light field data allowing imaging of a scene while enabling refocusing of the acquired image onto different object planes.

### BACKGROUND ART

References considered to be relevant as background to the presently disclosed subject matter are listed below:
[1] Marwah, Kshitij, Gordon Wetzstein, Yosuke Bando, and Ramesh Raskar. “Compressive light field photography using overcomplete dictionaries and optimized projections.” ACM Transactions on Graphics (TOG) 32, no. 4 (2013)L 46
[2] Mendlovic, David, Ran Schleyen, and Uri Eliezer Mendlovic. “SYSTEM AND METHOD FOR LIGHT-FIELD IMAGING.” U.S. Patent Publication 2017/0201727
[3] Aharon, Michal, Michael Elad, and Alfred Bruckstein. K-SVD: An algorithm for designing overcomplete dictionaries for sparse representation.” IEEE Transactions on signal processing 54.11 (2006): 4311-4322.
[4] Duarte-Carvajalino, J. M., & Sapiro, G. (2009). Learning to sense sparse signals: Simultaneous sensing matrix and sparsifying dictionary optimization. IEEE Transactions on Image Processing, 18(7), 1395-1408.
[5] Elad, M. (2007). Optimized projections for compressed sensing. IEEE Transactions on Signal Processing, 55(12), 5695-5702.

Acknowledgement of the above references herein is not to be inferred as meaning that these are in any way relevant to the patentability of the presently disclosed subject matter.

### BACKGROUND

The Light Field (LF) technology is used in photography, and especially in light field cameras (plenoptic cameras). In such cameras, information about the captured light field coming from a scene includes intensity of light in the scene and the direction of the light beams propagation in space. The light field is the sum of all photons traveling in all directions throughout a known 3D space. This field may be represented by a 5D plenoptic function. Another approach to represent a LF is by using 4D geometrical representation, which only gives the direction in space of each light ray. The LF function provides the amplitude and wavelength of each ray. Using this information, the geometrical location source point of each group of rays can be estimated and a 3D scene can be reconstructed.

There are several ways to capture the LF of a scene. The method of Light Field Rendering (LFR) was one of the first practical attempts to capture the LF of a specific open space. LFR makes use of one traditional digital camera, which travels within a defined space while capturing images along the way. The method of Micro-Lens Array (MLA) for LF capturing is a method used for commercialized LF cameras (manufactured by Lytro or Raytrix, for example). MLA uses an array of micro lenses placed near the camera sensor.

Marwath et al. state that light field photography has gained a significant research interest in the last two decades; today, commercial light field cameras are widely available. Nevertheless, most existing acquisition approaches either multiplex a low-resolution light field into a single 2D sensor image or require multiple photographs to be taken for acquiring a high-resolution light field. Marwath et al. propose a compressive light field camera architecture that allows for higher-resolution light fields to be recovered than previously possible from a single image. The proposed architecture comprises three key components: polychromatic light field atoms as a sparse representation of natural light fields, an optical design that allows for capturing optimized 2D light field projections, and robust sparse reconstruction methods to recover a 4D light field from a single coded 2D projection. In addition, Marwath et al. demonstrate a variety of other applications for light field atoms and sparse coding techniques, including 4D light field compression and denoising.

U.S. Patent Publication 2017/0201727, assigned to the assignee of the present application, describes a light-field imaging system and a method for generating light-field image data. The system comprising an imaging lens unit, a detector array and a polychromatic patterned filter located in optical path of collected light, being at an intermediate plane between the lens unit and the detector array. The method comprising: acquiring image data of a region of interest by passing input light coming from said region of interest through said imaging lens unit and said polychromatic patterned filter to be detected by said detector array to generate corresponding image data; and processing said image data to determined light components passing through different regions of said polychromatic patterned filter corresponding to different colors and different parts of the region of interest to provide light-field image data of said region of interest.

One application of Light Field technology is depth estimation, which relies on the disparity that a LF optical system can provide and evaluates the depth using objects similarity shifts. With a reliable depth map, a high security facial authentication tool can be created, that is robust to 2D hacking attempts (like placing an image/screen in front of the device). Other uses of the Light Field technology include post exposure refocus or image segmentation.

### GENERAL DESCRIPTION

There is a need in the art for a novel light field (LF) imaging technique which provides an improvement in the quality of the light field image. More specifically, it would be advantageous to have a LF imaging technique that provides higher Peak signal-to-noise ratio (PSNR). PSNR is used to measure the quality of image reconstruction. The signal is indicative of the original scene, and the noise is the error introduced by image compression.

As described above, one of the known techniques is the LFR. However, in order for LFR to work, the fixed position in space of each image is to be taken with accuracy at the scale of the scene's details. LFR suffers from some significant flaws. First, since the images are captured in different times it is crucial that there will not be any movement in the scene in order to maintain continuity. Furthermore, there cannot be any illumination changes, including light arrival directions, shadows etc. The same principal idea of LFR can also be executed by using a synchronous camera array.

As for the other known technique utilizing MLA for LF capturing, here each micro lens is referred to as a mother pixel, and the group of pixels behind it receives only the light that passes through the mother pixel. Thus, each pixel behind a mother pixel receives only the light that comes from the corresponding area of the camera aperture. Therefore, a different viewpoint of the scene can be extracted using the correct down sampling of the sensors data. MLA suffers from a great loss in image resolution. Since the resolution of each viewpoint is determined by the number of mother pixels, a 25 MP MLA camera, which creates 25 different viewpoints, will produce 1 MP images. In addition, the aperture diameter is reduced by the number of sub-pixels in each direction, which results in an expansion of the depth of focus.

The present invention provides an LF imaging technique, which uses a single imager (camera). The technique of the present invention utilizes an optical coder that applies angular coding to input light field being collected and produces angularly coded light. Such angular optical coding includes separation of the input light into a plurality of angular light components corresponding to the respective plurality of different discrete viewpoints of the scene, and projecting each of these angular light components onto the same region (e.g. pixel, or a set of pixels) of the pixel matrix. Thus, each region (e.g. pixel) of at least a part of the pixel matrix receives light from all the angular light components. By this, summation of the plurality of angular light components on said region (pixel) of the pixel matrix of the sensor is obtained, i.e. a so-called in-pixel summation: every pixel in the pixel matrix receives the light collected from all the viewpoints.

Thus, contrary to the known techniques in the field in which a standard lens or lens stack is used to project one image on an imaging plane (like in a standard imaging system), the present invention utilizes the optical coder, which projects a number/plurality of different viewpoints on the same imaging plane, creating a summation of images on the pixel matrix of the sensor. The optical coder may include a lens or a lens stack with multiple irises on the same aperture plane, or alternatively, a multiple lenses structure that are parallel to each other in order to project an image on the same sensor plane.

The plurality of the angular light components, on their way to the pixel matrix, undergo predetermined color coding, while not affecting the above-described projection/propagation of the angular light components to the pixel matrix. As a result, an image of the input light field in a spectro-angular space is formed on the pixel matrix. It should be understood that the present invention utilizes a coded optical filter (applying said predetermined color coding), which is located in a space between the optical coder and the pixel matrix. Due to its location, such filter codes every viewpoint differently, but still every pixel in the sensor receives the light from all the viewpoints (with different intensity and/or wavelength).

Further, the present invention preferably utilizes a monochromatic camera sensor for any black-and-white or color space light field including an IR channel, rather than using a camera sensor with CFA in order to achieve a color light field.

It should also be understood that according to the present invention, every color channel is not necessarily distributed equally. In order to achieve the higher light efficiency, pixels may be added that are transparent (or have higher transparency) in more than one color channel.

The present invention thus provides for spatial compression and wavelength (color channels) compression of image data on a monochromatic sensor/detector. Further, the invention advantageously provides for processing measured compressed information embedded in the output of the detector, since every pixel measures a summation of the light that comes from all the viewpoints and all the color channels at once. Therefore, data processing solves compressed sensing tasks using notions from the field of sparse representation or neural networks.

The present invention can be advantageously used in various applications. Examples of such applications include: color light field imaging based on obtaining multiple standard (“2D”) color image representing different viewpoints, providing angular/depth information, and which can be used for distinguishing between different objects within the image, image refocusing, depth estimation, etc. Also, the invention can be used for authentication imaging, acquiring a 2D image of a person's iris in a specific wavelength band and a depth image of the user face Moreover, the invention provides for using light field image for 3D face authentication. This can be implemented by acquiring two (or more) 3D images of the face in different wavelength range or specific color (e.g., green, white, IR etc.). Such technique is flexible in terms of sensitivity towards ambient light conditions, e.g. in low light conditions, the IR wavelength is used (e.g. using an external illuminator, such as a LED), and while in normal light conditions the visible color can be used.

Thus, according to one broad aspect of the invention, it provides a light-field imaging system comprising:

an optical arrangement configured for collecting an input light field from a scene and projecting collected light on a pixel matrix of a detector unit, the optical arrangement comprising an optical coder configured for applying angular coding to the light being collected to produce angularly coded light by separating the light being collected into an array of u angular light components corresponding to u different discrete viewpoints of the scene and projecting light from all of said u angular light components onto each pixel of at least some pixels of the pixel matrix thereby causing in-pixel summation of the u angular light components on the pixel matrix of the sensor unit; and

a color filter unit located in a filtering plane in an optical path of the u angular light components of the angularly coded light and is configured to apply predetermined color coding to the angularly coded light propagating to the pixel matrix to thereby form on the pixel matrix an image of the input light field in a spectro-angular space such that each pixel of the pixel matrix receives the light from all the viewpoints with a certain intensity and wavelength profile.

It should be understood that with the above configuration of the optical arrangement, the summation of the angular light components associated with multiple viewpoints of the scene being imaged is an in-pixel summation, where every pixel in the pixel matrix receives the light collected from all the u discrete viewpoints (with different intensity and \or wavelength). Thus, output of the detector unit comprises compressed measured data indicative of two-dimensional compression (i.e. spatial compression and wavelength compression) of the light field being collected.

Thus, data indicative of the collected light provides for image reconstruction of the input light field in the spectro-angular space. In some embodiments, the optical coder comprises an array of spaced-apart optical windows (e.g. apertures, microlenses, a pattern integral in a microlens array) to implement said separation of the light being collected into the u angular light components. In some embodiments, the optical arrangement further comprises one or more light directing elements (e.g. one or more lens elements or apertures).

As described above, in some preferred embodiments, the detector unit is monochromatic.

The coded color filter unit may comprise multiple filter elements of at least two groups, each group having a different light transmission spectrum, the filter elements being arranged with a predetermined spatial pattern. In some embodiments, the filter elements of the at least two groups have preferred transmission in, respectively, two or more different wavelength ranges. One of the two or more wavelength ranges may correspond to white color (i.e. the respective filter elements are transparent to the entire visible spectrum); or to IR range.

In some embodiments, the filter elements are configured as one or more binary patterns with respect to one or more wavelength ranges, respectively. The binary pattern may be random, which allows for maximizing the spatial separation between the viewpoints and color channels. In some embodiments, the filter elements of two or more different groups transmit light of at least two wavelength bands, respectively, comprising a combination of wavelength bands selected from the following: red, green, blue, cyan, magenta, yellow, white. In some embodiments, filter elements include at least three binary patterns, transmitting red, green, and blue (RGB) colors, respectively.

In some embodiments, the color filter, accommodated downstream of the optical coder (e.g. array of spaced-apart optical windows/cells), is configured for transmitting at least one light wavelength band. Such a system can advantageously be used in a light field imaging system aimed at object (e.g. face) recognition for the purposes of authentication.

As indicated above, in some other embodiments, the optical coder (e.g. array of spaced-apart optical windows/cells) is followed by the filter unit comprising at least two color filtering cells. This system configuration can advantageously be used for feature identification, e.g. face.

The above-described system of the invention can be used together with/adjacent to a standard camera unit. For example, the optical coder operates to encode different number of vertical viewpoints as compared to that of encoded horizontal viewpoints: encodes a higher number of vertical viewpoints than horizontal viewpoints or vice versa, this example may be used for application where the measured object as different noticeable disparity in different directions. In yet another example, an image acquired by the standard camera serves as an additional viewpoint for the light field camera.

As indicated above, in some embodiments, the color filter has a binary pattern. In this connection, it should be understood that such a binary pattern means that each filter element/cell defines a certain color channel or wavelength range, while different channels may overlapped in their spectrums.

For example, the filter's transmission is within a single band pass. In some embodiments of this configuration, the system may include an additional optical band pass filter (e.g. IR cut filter in a standard imaging system in the visible wavelength range). The filter's transmission may be within the IR spectral range.

As also indicated above, the color filter may be configured for transmission of two colors (wavelength bands). Such a two-color filter configuration may be implemented by using an additional optical dual bandpass filter in the optical arrangement, e.g. having at least one of the transmission windows within the IR wavelength range. In the two-color filter configuration, the distribution of the colors across the filter's transmission window may be not uniform.

In some other embodiments, the multi-color filter configuration may be used transmitting at least three colors (e.g. with non-uniform color distribution). These may include any combination of the following colors: red, green, blue, cyan, magenta, yellow, white, single IR band etc. The multi-color system configuration may be implemented by using an additional optical multi bandpass filter within the optical arrangement. This may be for example, an IR cut filter, or a filter with at least one of the transmission windows being within the IR wavelengths range.

The above-described optical arrangement used in the light-field imaging system is thus configured such that each of the angular light components carries and projects on the pixel matrix a different spatial pattern. The system is therefore characterized by a modulated effective sensing matrix ϕ, eliminating averaging of the viewpoints. More specifically, the modified effective sensing matrix ϕ is defined as:

$$φ = \frac{1}{mn} - [ \begin{matrix}{φ}_{1} & … & {φ}_{mn}\end{matrix} ] \qquad ( 6 )$$

where ϕᵢ is a diagonal matrix, which contains measured data from a column of pixels in the pixel matrix, when the color filter projects light collected by the i-th optical window (aperture or lens); here i=1, 2, . . . mn; n and m being the size of the angular and wavelength channels.

The above described system, of any of its embodiments, is associated with/comprises a signal/data processor unit/module. The latter is in signal communication with the detector unit and is configured to receive, from the detector unit, the measured compressed data indicative of raw image data of a scene and process the raw image data in accordance with data indicative of the modified effective sensing matrix (e.g. the filter's characteristic (transmission patterns)) to create reconstructed image data of the scene.

The invention, in its further broad aspect provides a light-field imaging system comprising: an optical arrangement configured for collecting an input light field from a scene and projecting collected light on a pixel matrix of a detector unit, the optical arrangement comprising an optical coder configured for applying angular coding to the light being collected to produce angularly coded light by separating the light being collected into an array of u angular light components corresponding to u different discrete viewpoints of the scene and projecting all of said u angular light components onto each of at least some of the pixels in the pixel matrix thereby causing in-pixel summation of the u angular light components on the pixel matrix of the sensor unit; and a color filter unit located in a filtering plane in an optical path of the u angular light components of the angularly coded light and is configured to apply predetermined color coding to the angularly coded light propagating to the pixel matrix while allowing said projection of the u angular light components; said light field imaging system being characterized by a modulated effective sensing matrix ϕ, eliminating averaging of the viewpoints and forming on the pixel matrix an image of the input light field in a spectro-angular space.

The invention also provides a light field imaging method comprising: collecting an input light field from a scene and projecting collected light on a pixel matrix of a monochromatic detector unit, said collecting and projecting comprising: applying angular coding to the light being collected to produce angularly coded light by separating the light being collected into an array of u angular light components corresponding to u different discrete viewpoints of the scene and projecting light from all of the u angular light components onto each pixel of the pixel matrix, to thereby cause in-pixel summation of the u angular light components on the pixel matrix; and applying predetermined color coding to the angularly coded light propagating to the pixel matrix to thereby allow said in-pixel summation of the u angular light components and form on the pixel matrix an image of the input light field in a spectro-angular space.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a block diagram of a light field imaging system of the present invention;

FIGS. 1B to 1D schematically illustrate specific, not limiting, examples of the configuration of the optical coder in the light field imaging system of FIG. 1A;

FIG. 2 shows a simulation of the reconstructed PSNR as a function of light efficiency, for the system configuration using RGBW filter;

FIG. 3 is a block diagram of an exemplary processing utility for processing raw image data received from the detector unit for reconstructing an image of the scene;

FIG. 4 is a graph illustrating a simulation of the reconstruct LF PSNR as a function of the filter's grayscale levels; and

FIG. 5 is a graph illustrating a simulation demonstrating reconstruction quality and noise robustness for different filter designs.

### DETAILED DESCRIPTION OF EMBODIMENTS

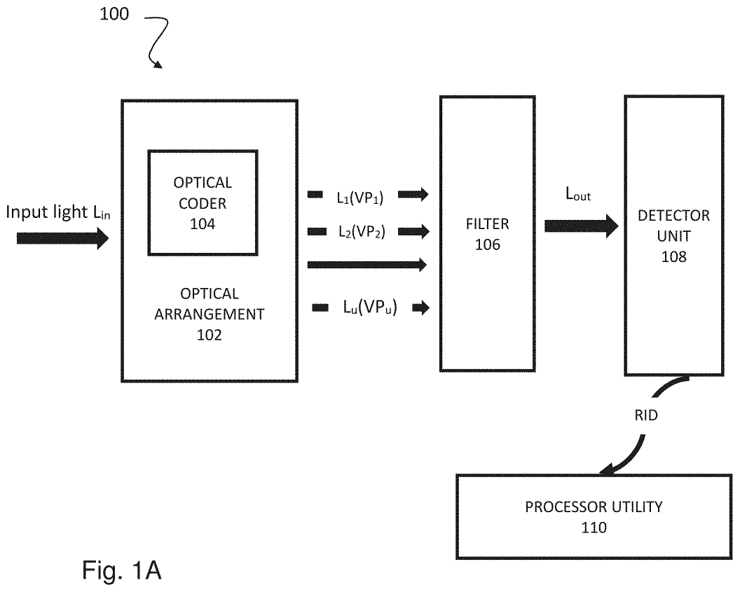

Referring to FIG. 1A, there is schematically illustrated, by way of a block diagram, a light field imaging system 100 of the present invention. The system 100 includes an optical arrangement 102, a filter 106, and a detector/sensor unit 108 having a pixel matrix. The detector 108 may be in signal communication with a data processor module/circuit 110.

The optical arrangement 102 is configured for collecting input light field Lin from a scene, creating output light Lout, indicative of projection of the collected input light field onto the pixel matrix of the detector 108 which may be monochromatic. Image data generated by the detector unit 108 then undergoes post-processing by the processor utility 110. To this end, the output circuit of the detector unit 108 is connected to (or, generally, is connectable to by wires or wireless signal transmission) the processor utility 110, which may thus be part of the system 100 or a stand-alone or server utility connectable to the system via communication network.

The optical arrangement 102 includes an optical coder 104 (and may also include one or more light directing elements, e.g. one or more lenses). The optical coder 104 is configured to apply angular coding to the collected input light field Lin to thereby produce angularly coded light in the form of a plurality/array of angular light components corresponding to projections of the respective plurality of different discrete viewpoints of the scene onto the pixel matrix of the detector. More specifically, the optical coder 104 performs such angular coding by separating the input light field Lin being collected into u angular light components, L₁(VP₁), L₂(VP₂), . . . , Lᵤ(VPᵤ), corresponding to u different discrete viewpoints VP₁, VP₂, . . . , VPᵤ of the scene, and projects light from all of these viewpoints onto each pixel of the pixel matrix (or each pixels of at least some/sub-set/group of the pixel matrix) of the detector unit 108, thereby causing in-pixel or within-pixel summation of these u light components on the pixel matrix of the detector unit.

These angular separated light components, on their way to the detector unit, interact with the color filter unit 106. As will be described more specifically further below, the color filter unit may include filter elements from at least two groups, where each group has different light transmission spectrum, with a predetermined spatial arrangement/pattern of the filter elements. As also will be described more specifically further below, the color filter 106 located in the optical path of the angularly coded light components propagating to the pixel matrix codes every viewpoint differently, while not affecting the propagation/projection of said separated light components to allow every pixel in the sensor to receive the light from all the viewpoints (with different intensity and \or wavelength).

Generally, the optical coder 104 includes an array of spaced-apart optical windows (one- or two-dimensional array), and may also include additional optical elements, e.g. lenses. Referring to FIGS. 1B-1D, there are schematically illustrated three specific, but not limiting examples of the configuration of the optical coder 104. To facilitate understanding, the same reference numbers are used to identify components that are common (functionally) in all the examples.

As shown in the example of FIG. 1B, the optical coder 104 may include an array of optical windows, such as apertures/pupils, and may also include other optical elements, e.g. lenses 105. As further shown in the example of FIG. 1C, such optical elements 105 are in the form of microlens arrays MLAs. In the example of FIG. 1D, the optical windows are implemented as a pattern within an MLA, i.e. partially obscured MLA (with or without additional lenses).

In the description below, such optical windows of the optical coder 104 are at times referred to as “apertures”, but it should be understood that this term should be interpreted broadly as a matrix/array of elements the arrangement of which is configured for transforming the light being collected into angularly separated light components corresponding to different discrete viewpoints of the scene.

Further provided in the system 100 is an optical filter 106. The filter 106 is located downstream of the apertures 104 with respect to a general propagation direction of light through the system 100. In other words, the filter is located in the optical path of the coded light (angularly separated light components), and defines a filtering plane in between the apertures 104 and an imaging plane defined by the pixel matrix.

In some embodiments, the filter 106 is polychromatic, and has a pattern formed by a predetermined arrangement of filter elements/cells comprising the elements of two or more groups. The two or more groups of the filter elements have preferred transmission in, respectively, two or more different wavelength ranges. In some embodiments, one of the wavelength ranges corresponds to white color (i.e. respective filter elements are transparent to the whole visible spectrum). This will be described more specifically further below.

Thus, the optical coder (aperture array) 104 separates the input light being collected by the system from the scene into multiple discrete viewpoints, i.e. applies angular separation of the collected light, and projects the angular components onto the sensing plane such that each pixel receives a light portion including all the angular components. The filter 106 applies slightly different color coding to each angular component of the so-produced angularly separated light. As a result, light Lout reaching the detector unit 108 presents an image of the input light field Lin in a spectro-angular space. In a preferred embodiment of the present invention, the detector unit 108 is monochromatic. The light components corresponding to the different viewpoints (and colors) are then summed up on a light sensitive surface (pixel matrix) of the detector unit. The system 100 thus is able to compress both the angular information and the color information on the monochromatic sensor.

It should be noted that the array of optical windows 104 separates the image into different viewpoints, to a level that distinguishable disparities are created in a pixel size scale of the detector unit. In the absence of such aperture array, the viewpoints and the disparity vary continuously with the ray directions. The aperture array 104 also creates distinguishable filter projections on the detector, which helps to define the quality of the sensing matrix ϕ, as will be explained below.

In some embodiments of the present invention, each aperture/optical window is relatively small due to the limited diameter of the iris in a LF camera. Generally, each optical window in the array is small enough, so a number of optical windows can be placed in the area of the main aperture defined by the original iris of the LF camera. This means that there only is an upper bound to the size of the optical window which is dependent on the number of optical windows to be used and a given size of the system iris. The size of the apertures in the array determines the depth of field (DOF) and noise level of each view point. The size is selected according to the tradeoff between DOF and noise and according to the application for which the light field system is designed for. In general, increasing the size of the apertures will reduce noise and improve LF reconstruction, while taking into account issues related to vignetting.

Due to the spatial redundancy of light field images and thanks to computational achievements in the field of machine learning, high performances on light field related applications can be achieved with at least two apertures in the array 104. Two apertures provide disparity information in only one direction (like stereo vision), and in order to achieve disparity in two orthogonal directions, at least three (non collinear) optical windows are required. Regardless of the number of apertures in the array 104, the farther the most distant apertures are positioned from each other within the system's iris the more disparity is extracted from the scene. In a circular camera iris, a four-aperture array will provide maximum horizontal and vertical disparity. In practice, there are some limitations for placing the apertures 104 at the borders of the system's iris due to vignetting effects (a reduction of an image's brightness or saturation at the periphery as compared to the image center).

The shape of each aperture is not limited, and the apertures in the array may be of any shape/geometry, as well as may be of the same or different shapes. Different aperture shapes could be used for various light field applications. Also, the number of apertures may change for various applications.

Ignoring the filter array, the summation of the different angular light components intensities (corresponding to the different viewpoints) on the pixel matrix can mathematically be represented by:

$$\begin{matrix}{y}_{n \times 1} = {φ}_{n \times m} {x}_{m \times 1} + N , n < m & ( 1 ) \\ φ = \frac{n}{m} [ \begin{matrix}\begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix} & ⋯ & \begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix} ]\end{matrix} & ( 2 )\end{matrix}$$

where y is a column stack (vector) representation of the pixels' measurement by detector (having n pixels arranged in 2D array), x is a column stack LF projected on the n detector pixels from a finite number of apertures u, so that m=n×u, ϕ is the sensing matrix, which compresses (sums and normalize) all the projections from each aperture to one detector pixels, N is noise, n is the number of pixels in the matrix, and m is the number of projection points (i.e. number of apertures/optical window u multiplied by n).

The above equation is an overcomplete problem with infinite solutions [1], so x cannot not be recovered with traditional tools. It should be noted that the example presented here utilizes a compressed sensing (CS) problem (overcomplete problem), which is based on sparse representation (SR), i.e. a mathematical field, which uses a number of algorithms that solve the CS problem under certain assumption which lead to the conclusion that in order to solve this type of problems, an encoder optical filter is needed. In the example presented here, the theory of SR thoroughly is used. However, it should be noted that it is not the only methodology that solves CS, as will be discussed later.

Thus, let us practice the theory of Sparse Representation (SR) and Compressed Sensing (CS). Assume that under a known linear transformation D, named dictionary, x can have k-sparse representation x=Dα, so that the problem can be written as:

y_{n×1}=A_{n×\grave{m}}α_{\grave{m}×1}+N,A_{n×\grave{m}}=Φ_{n×m}D_{m×\grave{m}},∥α∥₀≤k (3)
\grave{m}≥, m>n

It has been proven that a unique solution for the linear system above exists provided that

k<½(1+1/μt(A)). (4)

Then, this solution is necessarily the sparsest possible. μ(A) is the mutual coherence of the matrix A, which is defined as follows:

$$μ ( A ) = {max}_{1 \leq i , j \leq m , i \neq j} \frac{\vert {a}_{i}^{T} {a}_{j} \vert}{{‖ {a}_{i} ‖}_{2} {‖ {a}_{j} ‖}_{2}} \qquad ( 5 )$$

Using the discrete cosine transform (DCT) or Wavelet transform as a dictionary does not provide a good sparse representation of the light field, x. Therefore, it has been suggested to use a learning mode for a dictionary using the K-SVD algorithm presented in reference [3] above, which gave a significant improvement in the results.

However, there is a significant flaw when trying reconstruct the high dimensional LF x from the compressed measurement y. While the K-SVD algorithm ensures a sparse representation for LF, the learned matrix D usually suffers from high mutual coherence. Moreover, the multiplication of D with ϕ which averages all the angular dimensions, only increases the mutual coherence of the total matrix A=ϕD.

The system of the present invention solves the above problems by providing a modulated/effective sensing matrix ϕ. This is implemented in the system 100 of the invention by placing a spatially patterned filter array 106 (a so-called “optical magnitude filter”) in a space between the pixel matrix 108 and the optical arrangement 102. As indicated above, the filter 106 is configured with a predetermined spatial pattern of filter elements of different groups (generally at least two groups).

Generally, with such a filter array 106 in the optical path of light emerging from the aperture array 104 (either directly or after passing through one or more optical elements 105), the light component coming from each aperture in the array 104 carries and projects on the pixel matrix 108 a different spatial pattern. In this manner, the effective sensing matrix ϕ no longer averages the viewpoints, and the reconstruction process becomes practical. The new effective sensing matrix ϕ is defined as:

$$φ = \frac{1}{mn} - [ \begin{matrix}{φ}_{1} & … & {φ}_{mn}\end{matrix} ] \qquad ( 6 )$$

where ϕᵢ is a diagonal matrix (i=1, 2, . . . nm; n and m being the size of the angular and wavelength channels), which contains the column stack of the detection units/measurement (pixels) when the filter projects light from aperture i. The apertures are numbered in a column stack form.

In addition to the above spatial compression, the color channels are compressed as well, by the spatial pattern of the spectral elements of the filter 106. In this manner, a color compression can be achieved on a monochromatic sensor/detector 108. In the example in which an RGB filter is used, to reconstruct the color LF from a monochromatic measurement, the above equations should be written as:

y_{n×1}=ϕ_{n×3m}x_{3m×1}+n (7)

ϕ=[ϕ_{R}ϕ_{B}ϕ_{G}] (8)

x=[x_{R}^{T}x_{G}^{T}x_{B}^{T}]^{T} (9)

In the example of RGB, the filter array 106 has at least three binary patterns, for example, three patterns transmitting the colors red, green, and blue (RGB), respectively. The binary implies that for example the red filter elements of the red binary pattern transmit the wavelength range of visible spectrum corresponding to the red color, and blocks the green and blue parts of the light, and the green and the blue filters behavior is similar (except for doing that for their corresponding wavelength ranges).

The solution described above, using sparse representation and dictionaries, is a non-limiting example. There are alternative solutions to the problem of reconstructing the colored light field x from the compressed pixel data y. Thanks to recent development in the field of machine learning, deep learning tools with emphasis on convolutional neural networks (CNN) also provide a method for solving CS problems. Using a vast and varied dataset, a neural network model can be well-trained to solve the CS problem, and provide a high quality reconstruction of the light field. The inventors have shown that the encoding filter array is required not only for the dictionary based solution of the CS problem as discussed before, but also for the CNN based method and every other CS solving techniques.

In the system 100, the reconstruction of the light field from the measured compressed pixel data is performed by the processor utility 110. The processor utility 110 is connected to the detector 108 and is configured for receiving raw image data RID from the detector 108 and processing these image data, utilizing known (input) data relating to the filter's pattern FP. The processor utility includes one or more software and/or hardware modules configured for storing and processing data, as described above. The processing utility 110 may have the architecture of Application Specific Integrated Circuit (ASIC), as known in the art.

In a dictionary based processor utility 110, the processor solves an optimization problem. Looking at equation (3) above, and having a known dictionary D and sensing matrix ϕ, we search for a solution α that minimizes the error between the modelled compressed image Aα (where A=ϕD) and the measured compressed image (given as the input) under certain constrains. The LF reconstruction is then formed by multiplying the dictionary D by the optimization solution α (i.e. Dα).

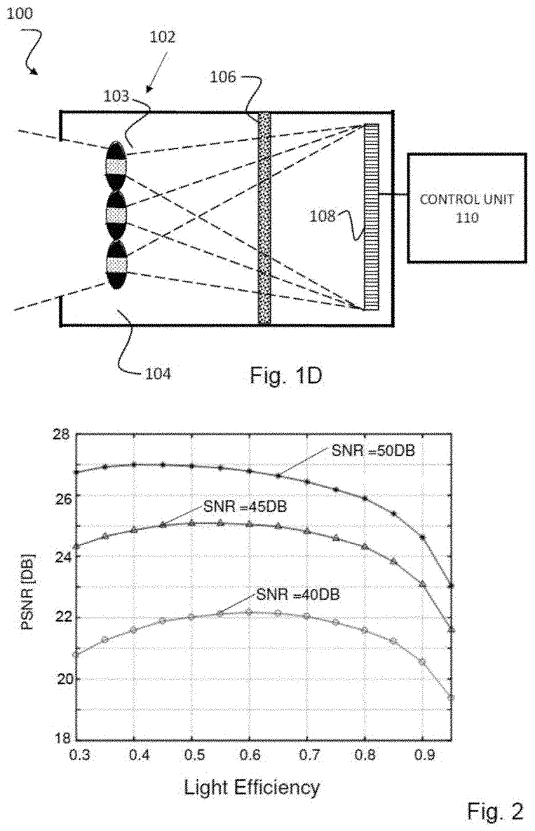

Reference is now made to FIG. 3 schematically illustrating an example of the configuration and operation of the data processing utility 110, configured for yielding image reconstruction data for reconstructing a light field of the scene. The processing utility 110 includes a data acquisition module 112, a pattern data module 114, a dictionary selection module 116, a function generation module 118, and an image reconstruction module 120. The processing utility 110 may be part of the system 100 (of the detector unit) or connectable to the system 100.

The data acquisition module 112 is configured for receiving raw image data RID either directly from the detector 108 of from a memory utility (not shown) in which the image data is stored. The pattern data module 114 is a memory utility which stores data about the pattern of the filter FP, i.e. the relevant sensing matrix. The dictionary selection module 116 is configured for selecting a dictionary D (although one dictionary may be applied to all data, different dictionaries may be more optimal for certain types of data) which converts raw image data RID into reconstructed light field data. The function generation module 118 is configured for receiving the raw image data RID, the pattern data FP, and the dictionary D, and for solving the optimization problem to find α. The image reconstruction module 120 is configured for applying the dictionary on α in order to yield the reconstructed light field data RLFD. The reconstructed light field data may be fed into an image construction unit, such as a computer, a display, or a printer, in order to create a reconstructed image.

In a processor utility based on sparse dictionaries representation technique, the processing utility should keep one or more dictionaries correlating raw image data to output data. These dictionaries are learned beforehand using the k-SVD algorithm as mentioned above, or any other suitable learning algorithm. For a CNN based processing, a training set of multiple viewpoint images and the resulting simulated compressed image (which depends on the sensing matrix) are used to learn the parameters of the network. Following the training phase, only the resulting network parameters and the network architecture are implemented within the processor utility.

We now return to discuss the details of the encoding filter array, The inventors have found that the light efficiency, the filter pattern, and the pixel size of the filter 106 can be configured in order to increase PSNR of the restored LF.

It should be noted that the previous work on the subject (reference [1] above), projected the filter pattern on the detector as a two matrixes bitwise multiplication operation. This assumption is impractical in the optical system described in FIG. 1. Since only one optical element can be placed on the focal point, either the filter 106 is out of focus or the detector 108 is shifted from the focal point, which results in an out of focus imaging.

Let us understand how different parameters/conditions of the filter and its physical properties affect the light field projection on the detector:
Filter placement—This parameter affects the blurring effect of the image. The farther the filter is placed from the detector, the blurrier the projection becomes. On the other hand, the filter's placement also affects the separation of the projections of the different viewpoints that project from different apertures of the optical coder. The farther the filter is placed from the detector, the better spatial separation is achieved.
Filter's pixel size—Ideally, each pixel on the projected detector should draw independently from its neighbors. In practice, if the filter's pixel size is set to the same scale as that of the detector, then the blurring effect could make the filter's pattern barely visible on the detector measurements. Reconstruction of compressed images is performed in patches and not as a single pixel operation, since images usually contain redundancy which can be found in the area around the pixel. Performing the reconstruction on larger patches that contain more information, usually provides better reconstruction. Therefore, in the system of the present invention, the filter projects the same color on a small group of pixels on the detector in order to reduce the blur effect (as the blur is most evident on the ends of the patch and not in the center of the patch). The reconstructed patches are significantly larger than the group of pixels with the same color projection. In this manner, the group gets separable projection from different apertures of the optical coder, and blur does not affect the reconstructed image.

It is important to note that the last section distinctions indicate that changing one pixel of the filter, changes the values for group of pixels on the detector. That is valid even when measuring the projection from one aperture. Therefore, it is not practical to change only one row in the sensing matrix f, without influencing the other rows. This observation is crucial for understanding why methods for improving the mutual coherence by choosing a certain filter pattern are not practical. In the general art, a variety of iterative optimization algorithms was proposed in references [4] and [5]. These algorithms suggest updating in each step only one row of the matrix ϕ and are therefore not practical.

Thus, below, a new approach for finding the filter characteristics for obtaining an increased PSNR is presented, that is independent of the location of the filter and of the pixel size of the filter.

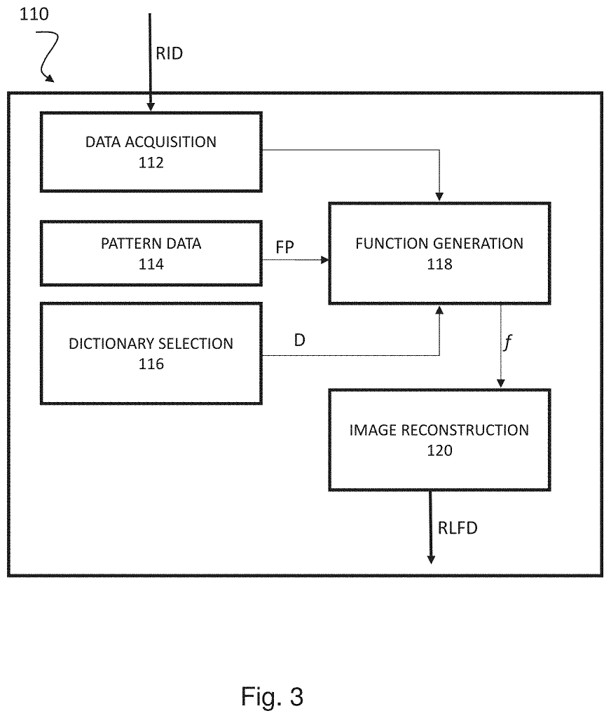

FIG. 4 include graphs illustrating a simulation conducted by the inventors, to determine the reconstructed LF's PSNR as a function of the filter's grayscale levels.

The graphs clearly show that for different signals sporting different SNR's, the PSNR is highest when the filter's grayscale levels are lower. This means that higher PSNR levels can be achieved when the filter approaches binary state, in which each portion/cell/element of the filter either fully transmits or fully does not transmit a certain wavelength (or a certain range of wavelengths).

As explained above, the coded filter decreases the mutual coherence of the system. It is well know that random matrices have low mutual coherence since they tend to spread an orthogonal space. Therefore, a random pattern is chosen for the filter, which will be reflected on the matrix ϕ. Since the filter of the present invention is an optical magnitude filter, the values can only exists in the range [0, 1]. In the general art, a uniform distortion in the range [0, 1] is used in order to imitate the behavior of random matrixes.

However, the inventors of the present invention have noted that most cameras use an 8-bit sensor for quantization of information. Therefore, using uniform distortion, nearby values on the sensor may not be distinguished in the presence of noise. In some embodiments of the present invention, the spatial separation between the light components associated with different viewpoints is increased, by using a random binary pattern. This pattern provides the maximum separation between the viewpoints and the color channels. While some information from a certain viewpoint may be completely lost in some pixels, this loss can be compensated since images are restored in patches using a well-trained dictionary or CNN, and data lost in one patch can be recovered from other patches (since images from different viewpoints have redundancy, as explained above).

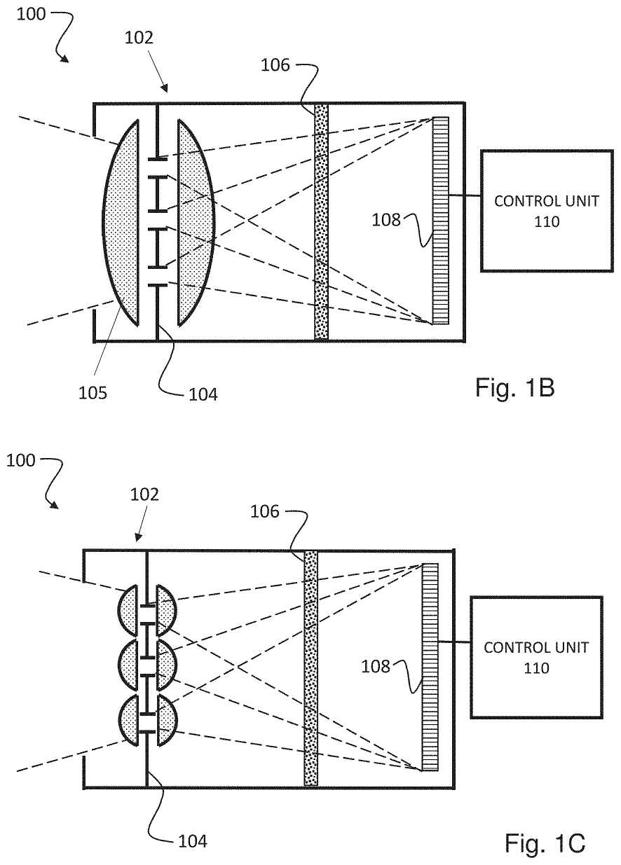

Turning back to FIG. 2, it illustrates a simulation conducted by the inventors to determine the reconstructed LF PSNR as a function of the filter's light efficiency. In the graphs, it is seen that the filter's light efficiency that produces signals with highest PSNR is between 0.4 (40%) and 0.7 (70%).

Light efficiency in an optical system is defined as a ratio between the visible light intensity which enters the system and the intensity measured on the detector. This index is measured in percentage. For example, if we ignore the intensity lost which is caused in the lens stack, the space between the pixels sensing areas, etc., in a standard camera, the Bayer filter causes the light efficiency to be ˜34%. More specifically, a standard RGB pattern will have light efficiency of ˜33.3%. This is because every color pixel (RGB) cuts approximately two-thirds of the visible light spectrum. In a practical Bayer filter, the green pixels have better light efficiency in the visible light than the red and blue. Therefore, since half of the pixels in a Bayer filter are green, the practical light efficiency is higher than ˜33.3%. the inventors have noted (via simulation) that when using a standard RGB color space, in a compressive light field camera with FPE that correspond to Bayer filter spectrum, the values of the light efficiency change accordingly. Since the color filter is represented as a random binary three-dimensional matrix (length, height and color), the light efficiency is only determined by the binary distribution probability in each entry of the matrix. It is tempting to set a high probability for choosing light efficiency=1 (transparent in a certain color channel), which leads to high light efficiency. However, the difference between the coding in each viewpoint decreases for a light efficiency of 1, and solving the problem described above becomes impractical. As seen by the graph of the simulation conducted by the inventors, when the filter has >40% light efficiency, the balance between the two conditions is obtained.

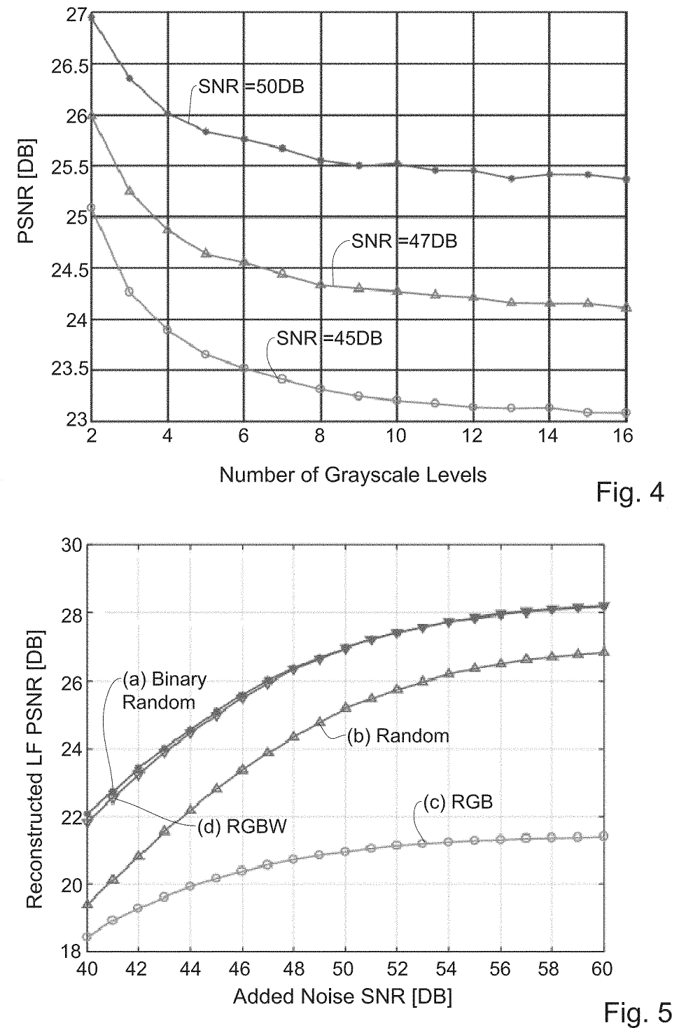

FIG. 5 illustrates simulation results demonstrating reconstruction quality and noise robustness for different filter designs including binary random, random, RGB and RGBW designs. In each element of the filter the transmittance of the RGB components of the light is randomly chosen in the range 0-1. For binary, the choice is taken between the values 0 and 1 only. Thus, a binary random design may include transparent, red, green, blue, yellow, magenta, cyan and opaque (black) filter cells. In RGB or RGBW designs the choice is done only between limited sets of the above filter cells. The simulation shows that a binary random filter design and a RGBW (transparent, red, green, and blue) yield highest PSNR. As mentioned above, the results of the grayscale simulation of FIG. 4 showed that a binary representation for the 3D filter matrix (height, width and color channel) provides the highest quality results. Since an RGB (red, green and blue) pattern is a subset of the binary representation, the use of an RGB filter rather than a yellow, magenta, and cyan filter may be preferable, as RGB patterned filters are easier to produce.

As mentioned above, in the description of FIG. 2, it would be advantageous to increase the light efficiency of the filter to >40%, which will improve the reconstruction process. To do this, white pixels (transparence) are added to the filter pattern. By just increasing the probability to choose white pixels, the filter's light efficiency can be controlled. For example, equal probability between the four (RGBW) produces 50% light efficiency (under a standard RGB color space), which is higher than the efficiency of the standard Bayer filter, and produces better reconstruction results as shown in the simulation. In addition, it should be noted that this modification still holds the filter in the binary subset.

As can be seen from FIG. 5, the most impressive reconstruction results can be achieved using the RGBW filter design of the present invention. In order to set the light efficiency of a random pattern, we need to set the probability to choose a white pixel.

LE=α·W+(1−α)(R+G+B) (10)

For example, using a standard RGB (sRGB) filter in which red, green, and blue colors are equally distributed and have equal light efficiency, we can define R=G=B=⅓, and W=1, then in order to receive LE=0.6 we need to choose α=0.4, i.e. a 40% probability to choose a white pixel.

In practice, color filters on digital sensors do not use the sRGB space and do not distribute the colors equally, since every color has different light efficiency. Therefore, the filter of the present invention has the total light efficiency of >40% and the distribution of the colors is dependent on the light efficiency of each color.

LE=α_{w}W+αᵣR+α_{g}G+α_{b}B such that α_{w}+αᵣ+α_{g}+α_{b}=1 (11)

where W, R, G and B are the light efficiency in the visible spectrum range for each color on the filter, and α_{w}, αᵣ, α_{g}, α_{b} are the distributions of the white, red, green, and blue filters respectively.

It should be noted that a filter with four binary patterns is only an example of filter of the present invention. In fact, according to some embodiments of the present invention, different numbers and different combinations of colors representing a known color space can be used. The generalized equation for LE can be written as:

LE=α_{w}W+Σₖ₌₁^{N}αₖCₖ such that α_{w}+Σₖ₌₁^{N}αₖ=1 (12)

where N is the number of colors defining a color space; C₁, C₂, . . . C_{N} are the colors defining the color space; and α₁, α₂, . . . α_{N} are the distributions of the colors C₁, C₂, . . . C_{N}, respectively.

The color optical filter may be manufactured using dielectric coating. This method uses one or more thin layers of material deposited on an optical component, which alters the way in which the optical component reflects and transmits light. For example, the optical component is the filter glass. Simple optical coating may be used for producing antireflection surfaces on optical component or produce mirrors that reflect greater than 99.99%. More complex optical coating exhibits high reflection over some range of wavelengths and anti-reflection over another range, allowing the production of dynamic band pass filters over the light spectrum. The dielectric coating thin layers may be constructed from materials such as magnesium fluoride, calcium fluoride, and various metal oxides, which are deposited onto the optical substrate. By proper choice of the exact composition, thickness, and number of these layers, the reflectivity and transitivity of the coating can be tailored to produce almost any desired characteristic. The thin layers could be placed on the substrate in specific patterns using a detected mask, which exposes only the desired pattern. In order to manufacture a polychromatic filter, numerous masks can be used with no overlapping region. Then, by placing carefully layers with different process for each mask, any desired polychromatic filter can be obtained.

Another suitable technique for the color optical filter manufacture utilizes color photoresist. A photoresist is a light-sensitive material used in several processes, such as photolithography and photoengraving, to form a patterned coating on a surface. The process begins by coating a substrate with a light-sensitive organic material. A patterned mask is then applied to the surface to block light, so that only unmasked regions of the material are exposed to light. A solvent (developer) is then applied to the surface. The photosensitive material is degraded by light and the developer dissolves away the regions that were exposed to light. A positive or negative photoresist-based lithography can be used. Photolithography is also used for optical filtering purpose, when the substrate is a transparent glass and the photoresist is mixed with a pigment in order to produce dynamic band pass filters over the light spectrum. In order to manufacture a polychromatic filter, numerous masks with no overlapping region can be used. Then, by exposing different color photoresist with each mask, any desired polychromatic filter can be obtained.

1. A light-field imaging system, comprising:
a detector having a pixel matrix;
an optical arrangement configured for collecting an input light field from a scene and projecting collected light on the pixel matrix,
wherein the optical arrangement
separating the collected light into u angular light components corresponding to u different discrete viewpoints of the scene and project light from the u angular light components onto each of a plurality of pixel regions of the pixel matrix;
wherein all the u angular light components are collected by the detector on each of the plurality of pixel regions; and
a color filter:
located in a filtering plane in an optical path of the u angular light components of the collected light,
having a plurality of filter elements including a plurality of transparent filter elements and a plurality of filter elements of at least two wavelength bands selected from a group comprising: red wavelength, green wavelength, blue wavelength, cyan wavelength, magenta wavelength, and yellow wavelength; and
configured to filter the light propagating to the pixel matrix, thereby forming on the pixel matrix an image of the input light field in a spectro-angular space;
wherein the plurality of transparent filter elements are transparent to visible spectrum and distributed in the in filtering plane such that a probability of one of the plurality of color filters to be a transparent filter element is at least about −40 percent.

2. The light-field imaging system of claim 1, wherein each pixel of each of the plurality of pixel regions receives the light collected from all the u discrete viewpoints with a certain intensity and wavelength profile.

3. The light-field imaging system of claim 1, wherein output of the detector comprises compressed measured data indicative of spatial compression and wavelength compression of the light field being collected.

4. The light-field imaging system of claim 1, wherein the detector is a monochromatic detector.

5. The light-field imaging system of claim 4, wherein output of the detector comprises compressed measured data indicative of spatial compression and wavelength compression of the light field being collected on the monochromatic detector.

6. The light-field imaging system of claim 1, wherein the optical arrangement comprises an array of optical windows arranged in a spaced apart relationship in a plane in an optical path of the input light field propagation.

7. The light-field imaging system of claim 1, wherein the optical arrangement comprises a microlens array; wherein each of the microlens having an aperture.

8-11. (canceled)

12. The light-field imaging system of claim 1, wherein the plurality of color filter are arranged in a predetermined spatial pattern.

13-15. (canceled)

16. The light-field imaging system of claim 131, wherein one of the plurality of filter elements comprises a plurality of filter elements of infrared (IR) band.

17. The light-field imaging system of claim 1, wherein the color filter comprises the plurality of filter elements are configured in a binary pattern with respect to a certain wavelength range.

18. The light-field imaging system of claim 17, wherein the certain wavelength range includes a single IR band.

19. (canceled)

20. The light-field imaging system of claim 1, wherein the at least two wavelength bands include red, green, and blue (RGB) color bands.

21. The light-field imaging system of claim 1, wherein the plurality of color filter elements are arranged in a random binary pattern for maximizing separation between the u different discrete viewpoints.

22. The light-field imaging system according to claim 1, wherein the optical arrangement is configured such that each of the angular light components carries and projects on the pixel matrix a different spatial pattern and, having a modulated effective sensing matrix ϕ, eliminating averaging of the viewpoints.

23. The light-field imaging system according to claim 22, wherein the modified effective sensing matrix ϕ is defined as:
$$φ = \frac{1}{mn} - [ \begin{matrix}{φ}_{1} & … & {φ}_{mn}\end{matrix} ]$$
where ϕᵢ is a diagonal matrix (i=1, 2, . . . nm; n and m being the size of the angular and wavelength channels), which contains measured data from a column of pixels in the pixel matrix, when the color filter projects light collected by the i-th optical window or lens.

24. The light-field imaging system according to claim 1, further comprising a data processor configured and operable to receive, from the detector unit, the measured compressed data indicative of raw image data of a scene and process the measured compressed data in accordance with data indicative of the modified effective sensing matrix, and generated data indicative of reconstructed image of the scene.

25. (canceled)

26. A light field imaging method comprising:
collecting an input light field from a scene,
separating the collected light into u angular light components corresponding to u different discrete viewpoints of the scene;
projecting light from the u angular light components onto each of a plurality of pixel regions of the pixel matrix;
wherein all the u angular light components are collected by a detector on each of the plurality of pixel regions; and
wherein the projecting comprises using a plurality of filter elements including a plurality of transparent filter elements and a plurality of filter elements of at least two wavelength bands selected from a group comprising: red wavelength, green wavelength, blue wavelength, cyan wavelength, magenta wavelength, and yellow wavelength for filtering the collected light at a filtering plane in an optical path of the u angular light components thereby forming on the pixel matrix an image of the input light field in a spectro-angular space;
wherein the plurality of transparent filter elements are transparent to visible spectrum and distributed in the in filtering plane such that a probability of one of the plurality of color filters to be a transparent filter element is at least 40 about percent.
